(19) United States
(12) Patent Application Publication
(10) Pub. No.: US 2009/0056215 A1
(43) Pub. Date: Mar. 5, 2009

(54) PLANTATION POT THAT FACILITATES REPLACEMENT OF SOIL

(76) Inventor: CHEN-SHENG YANG, Feng Yuan City (TW)

Correspondence Address: LEONG C LEI, PMB # 1008, 1867 YGNACIO VALLEY ROAD, WALNUT CREEK, CA, 94598, US

(21) Appl. No.: 11/847,336

(22) Filed: Aug. 30, 2007

(51) Int. Cl. A01G 9/02

(52) U.S. Cl. 47/66.1

(57) ABSTRACT

A plantation pot includes a primary pot body having a side wall and a bottom delimiting a first interior space for containing a first amount of soil for growing a plant or a flower. The bottom of the primary pot body forms a plurality of openings for drainage of water. A circumferential rim is formed on the bottom of the primary pot body and forms external threads. A lower pot body has a side wall and a bottom defining a second interior space containing a second amount of soil. The lower pot body has a top opening forming internal threads engageable with the external threads of the rim fit into the top opening to secure the primary and lower pot bodies together. The plant is allowed to extend roots thereof into the lower pot body through the openings defined in the bottom of the primary pot body.

### BACKGROUND OF THE INVENTION

(a) Technical Field of the Invention

The present invention relates to a plantation pot that is detachable for facilitating replacement of soil, and in particular to a plantation pot that comprises a primary pot body that is releasably connected to a top opening of a lower pot body so that soil contained in the lower pot body can be easily replaced by disengaging the lower pot body from the primary pot body, which also allows for trimming of roots of a plant or flower growing in the soil contained in the primary pot body with the roots extending into the lower pot body.

(b) Description of the Prior Art

Flower pots that are currently available in the market are an integrally formed receptacle or container in which soil is contained for growing or planting a flower or other plants. Such an integrally formed structure provides no movable parts so that separation of soil from the pot for replacement of soil or removal of the plant growing in the pot must be done by repeatedly knocking the pot to disengage the soil from the inside surface of the pot. Once the soil is completely released from the inside surface of the pot, the soil and the plant growing therein can be removed out of the pot. This is a tedious process and may unexpectedly damage the plant. In addition, some of the flower pots are made of plastics which age after being exposed to intense sun light for a long period of time. Such aged flower pots may get broken when the pots are subjected to repeated knocking. This not only loses a flower pot, but may also cause damage to an individual's eyes or body by a flying piece of the broken flower pot. Although replacing soil of the conventional flower pots is difficult, it is necessary to periodically replace the soil in order to make the plant grow well. For regular plants, replacing soil once a year is very common and this makes the plant grow very well.

In view of the above problem, the present inventor bases on years of manufacturing and development of products in the related fields to attempt to provide a plantation pot that overcome the above problems.

### SUMMARY OF THE INVENTION

The primary purpose of the present invention is to provide a plantation pot that comprises two pot bodies stacked over and connected to each other in a releasable manner, wherein an upper pot body contains soil for growing a plant therein and has a bottom that is fit into and threadingly secured to a top opening of a lower pot body, which also contains therein soil, so that the plant is allowed to have roots thereof extending into the soil of the lower pot body for better growth.

A second objective of the present invention is to provide a plantation pot that is constituted by an upper pot and a lower pot releasably connected to each other by threading so that the lower pot can be easily separated from the upper pot for soil replacement and root trimming.

To achieve the above objectives, in accordance with the present invention, a plantation pot is provided, comprising a primary pot body having a side wall and a bottom delimiting a first interior space for containing a first amount of soil for growing a plant or a flower. The bottom of the primary pot body forms a plurality of openings for drainage of water. A circumferential rim is formed on the bottom of the primary pot body and forms external threads. A lower pot body having a side wall and a bottom defining a second interior space containing a second amount of soil. The lower pot body has a top opening forming internal threads engageable with the external threads of the rim fit into the top opening to secure the primary and lower pot bodies together. The plant is allowed to extend roots thereof into the lower pot body through the openings defined in the bottom of the primary pot body.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a plantation pot constructed in accordance with the present invention;

FIG. 2 is a cross-sectional view of the plantation pot of the present invention in an assembled form;

FIG. 3 is an enlarged view of a circled portion of FIG. 2; and

FIG. 4 is a cross-sectional view illustrating an application of the plantation pot of the present invention in growing a plant or flower.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

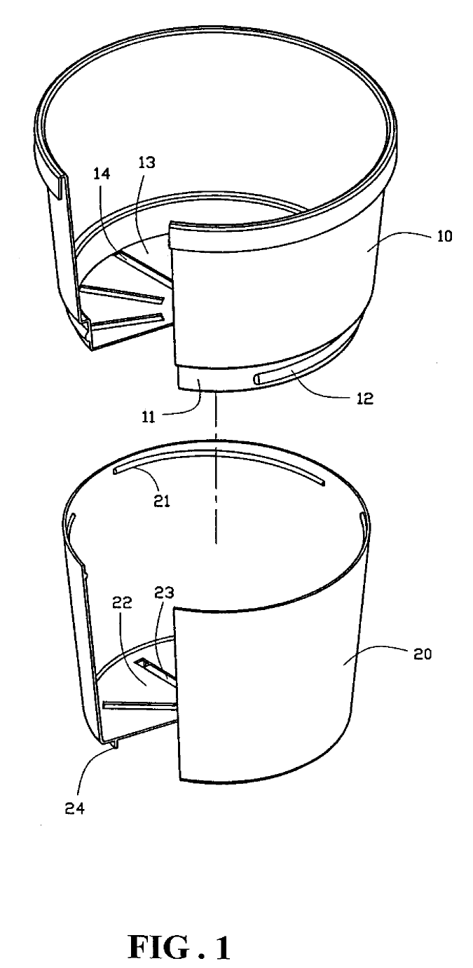

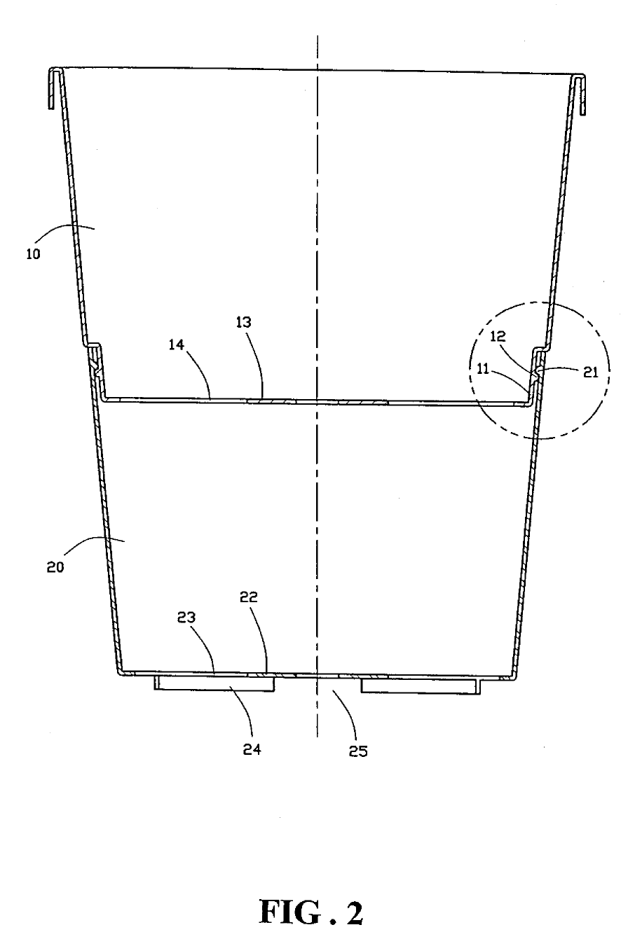

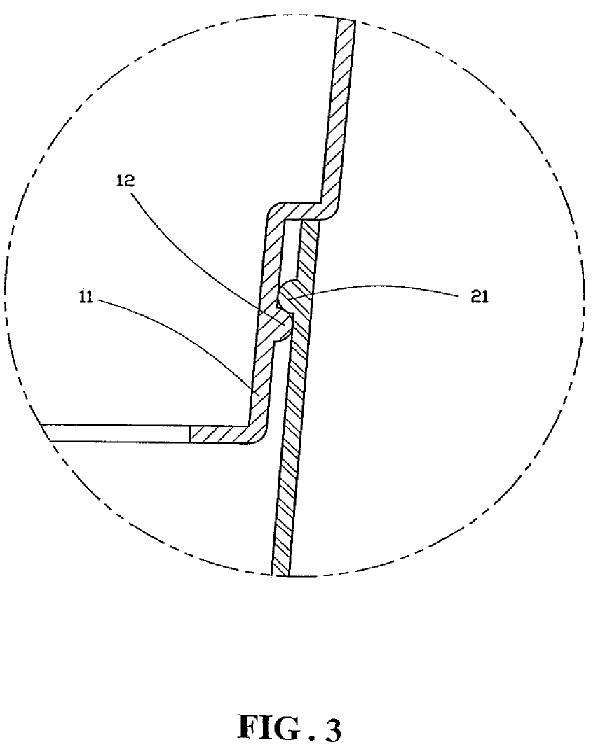

With reference to the drawings and in particular to FIGS. 1-3, a plantation pot constructed in accordance with the present invention is provided for facilitating replacement of soil contained therein. The plantation pot comprises a primary pot body 10 and a lower secondary pot body 20. The primary pot body 10 is in the form of a receptacle defining an interior space delimited by a circumferential side wall (not labeled) and a bottom 13 having a predetermined cross-sectional dimension, such as diameter for a cylinder-like pot body 10. A circumferential rim 11 is formed on an outer surface of the bottom 13 and has a cross-sectional dimension smaller than that of the bottom of the primary pot body 10. In other words, the rim 11 may circumvallate a cross-sectional area smaller than a surface area of the bottom 13 of the primary pot body 10. The rim 11 has a circumferential outer surface (not labeled) on which external threads 12 are formed. Further, the bottom 13 of the primary pot body 10 defines a plurality of openings 14 for water to pass therethrough.

The lower secondary pot body 20 is also in the form of a receptacle forming an interior space delimited by a circumferential side wall (not labeled) and a bottom 22. The circumferential side wall of the lower pot body 20 has an inside surface that forms internal threads 21 at a location adjacent to a top opening (not labeled) of the lower pot body 20. The top opening of the lower pot body 20 is shaped and sized to correspond to the rim 12 of the primary pot body 10.

The bottom 22 of the lower pot body 20 forms a plurality of openings 23 for discharging excessive water. In addition, arcuate projections or legs 24 are formed on an outside surface of the bottom 22 of the lower pot body 20 in a spaced manner so as to form gaps 25, which serve as water passages, between the legs 24. In the embodiment illustrated, the lower pot body 20 is of a cylindrical form and the arcuate legs 24 are arranged in a concentric manner with respect to the lower pot body 20 with the legs 25 angularly spaced from each other to define the water passages 25.

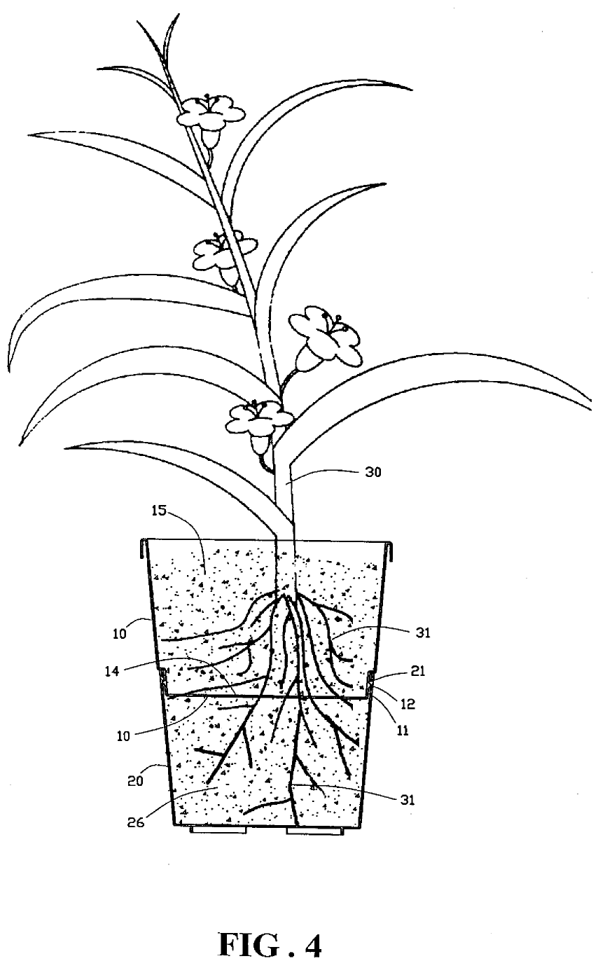

Also referring to FIG. 4, the interior space of the primary pot body 10 receives and contains therein a predetermined amount of soil 15 in which a flower or a plant 30 is planted. The primary pot body 10 is coupled to the lower pot body 20 by having the rim 11 fit into the top opening of the lower pot body 20, followed by relative rotation between the primary and lower pot bodies 10, 20 to have the external threads 12 and the internal threads 21 engaging each other. Soil 26 is put into and contained in the interior space of the lower pot body 20 so that roots 31 of the plant 30 that is planted in the primary pot body 10 are allowed to extend, through the openings 14 of the primary pot body 10 into the soil 26 of the lower pot body 20. Thus, in case there is a need to replace the soil or when it is desired to replace the soil, the lower pot body 20 is rotated with respect to the primary pot body 10 to release the lower pot body 20 from the primary pot body 10 and consequently, the soil 26 of the lower pot body 20 is exposed and can be removed easily to further expose the roots 31. The soil 26 of the lower pot body 20 can thus be replaced and the fibrous roots of the plant 30 can be properly trimmed before being put back into the new soil deposited in the lower pot body 20. The lower pot body 20 is then re-secured back to the primary pot body 20 by engagement between the threads 12, 21.

Although the present invention has been described with reference to the preferred embodiment thereof, it is apparent to those skilled in the art that a variety of modifications and changes may be made without departing from the scope of the present invention which is intended to be defined by the appended claims.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A plantation pot comprising a primary pot body and a lower pot body that are connectable to each other, the improvements comprising:
the primary pot body having a circumferential side wall and a bottom delimiting an interior space for receiving and containing a first amount of soil that is adapted to grow a plant, the bottom of the primary pot body forming a rim having a circumferential surface on which first threads are formed, the bottom of the primary pot body forming a plurality of openings; and
the lower pot body having a circumferential side wall and a bottom delimiting an interior space for receiving and containing a second amount of soil therein, the lower pot body having a top opening into which the rim of the primary pot body is fit, the lower pot body having an inside surface of the side wall thereof on which second threads are formed for mating engagement with the first threads to connect the lower pot body to the primary pot body, the bottom of the lower pot body forming a plurality of openings, legs being provided on an outside surface of the bottom of the lower pot body and spaced from each other to form passages therebetween;
wherein the plant growing in the first amount of soil contained in the primary pot body is allowed to have root extending through the openings of the bottom of the primary pot body into the second amount of soil contained in the lower pot body and wherein the lower pot body is selectively disconnected from the primary pot body to expose the second amount of soil for purposes of soil replacement and root trimming.
